(19) United States
(12) Patent Application Publication
(10) Pub. No.: US 2018/0213350 A1
(43) Pub. Date: Jul. 26, 2018

(54) TARGETED PRS CONFIGURATION SEARCHES

(71) Applicant: QUALCOMM Incorporated, San Diego, CA (US)

(72) Inventors: Rayman Pon, Cupertino, CA (US); Ju-Yong Do, Cupertino, CA (US); Guttorm Opshaug, Redwood City, CA (US)

(21) Appl. No.: 15/411,316

(22) Filed: Jan. 20, 2017

(51) Int. Cl. H04W 4/02; G01S 5/10

(52) U.S. Cl. CPC H04W 4/02; H04W 84/042; G01S 5/10

(57) ABSTRACT

Example methods, apparatuses, and/or articles of manufacture are disclosed herein that may be utilized, in whole or in part, to facilitate and/or support one or more operations and/or techniques for targeted positioning reference signals (PRS) configuration searches, such as for use in or with mobile communication devices, for example.

### BACKGROUND

### 1. Field

The present disclosure relates generally to position or location estimations of mobile communication devices and, more particularly, to targeted positioning reference signals (PRS) configuration searches for use in or with mobile communication devices.

### 2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless or electronic communications network. Acquired wireless signals may, for example, be processed by or at a mobile communication device, and its location may be estimated using known techniques, such as Advanced Forward Link Trilateration (AFLT), base station identification, cell tower triangulation, or the like.

In an indoor or like environment, such as urban canyons, for example, mobile communication devices may be unable to reliably receive or acquire satellite or like wireless signals to facilitate and/or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless transmitter devices, such as cellular base stations, access points, etc. positioned at known locations. Ranges may be measured, for example, by obtaining a Media Access Control identifier (MAC ID) address from wireless signals received from suitable access points and measuring one or more characteristics of received signals, such as signal strength, round trip delay, or the like.

In some instances, a position fix of a mobile communication device may be obtained in connection with an observed time difference of arrival (OTDOA) technique. In this technique, a mobile communication device may measure timing differences between reference signals received from two or more pairs of cellular base stations, for example, and may obtain a position fix based, at least in part, on known locations and transmission timing for the measured base stations. An OTDOA positioning technique may, for example, also be employed to assist in localization of a mobile communication device in the event of an emergency call, such as in compliance with Emergency 911 (E911) mandates from the Federal Communication Commission (FCC). At times, however, OTDOA positioning accuracy may be affected, at least in part, by one or more parameters indicative of a PRS configuration for one or more measured cellular base stations, such as provided to mobile communication devices as part of positioning assistance data, for example.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process for targeted PRS configuration searches.

FIG. 3 is a schematic diagram illustrating an implementation of an example computing environment associated with a mobile device.

FIG. 4 is a schematic diagram illustrating an implementation of an example computing environment associated with a server.

### SUMMARY

Example implementations relate to techniques for targeted PRS configuration searches. In one implementation, a method, at a mobile device, may comprise receiving, from a location server, one or more first messages comprising a request to utilize one or more parameters indicative of one or more positioning reference signals (PRS) configurations; obtaining one or more observations of signals indicative of the one or more PRS configurations based, at least in part, on the request; and transmitting one or more second messages to the location server, the one or more second messages comprising the one or more obtained observations of the signals indicative of the one or more PRS configurations.

In another implementation, an apparatus may comprise means for receiving, from a location server, one or more first messages comprising a request to utilize one or more parameters indicative of one or more positioning reference signals (PRS) configurations; means for obtaining one or more observations of signals indicative of the one or more PRS configurations based, at least in part, on the request; and means for transmitting one or more second messages to the location server, the one or more second messages comprising the one or more obtained observations of the signals indicative of the one or more PRS configurations.

In yet another implementation, an apparatus may comprise a communication interface coupled to a receiver of a mobile device to communicate with an electronic communications network and one or more processors coupled to a memory and to the communication interface, the communication interface and the one or more processors configured to receive, from a location server, one or more first messages comprising a request to utilize one or more parameters indicative of one or more positioning reference signals (PRS) configurations; obtain one or more observations of signals indicative of the one or more PRS configurations based, at least in part, on the request; and initiate a transmission of one or more second messages to the location server, the one or more second messages comprising the one or more obtained observations of the signals indicative of the one or more PRS configurations.

In yet another implementation, an article may comprise a non-transitory storage medium having instructions executable by a processor to receive, from a location server, one or more first messages comprising a request to utilize one or more parameters indicative of one or more positioning reference signals (PRS) configurations; obtain one or more observations of signals indicative of the one or more PRS configurations based, at least in part, on the request; and initiate a transmission of one or more second messages to the location server, the one or more second messages comprising the one or more obtained observations of the signals indicative of the one or more PRS configurations. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, and/or articles of manufacture are disclosed herein that may be implemented, in whole or in part, to facilitate and/or support one or more operations and/or techniques for targeted PRS configuration searches for use in or with mobile communication devices. For example, in some instances, one or more operations and/or techniques for targeted PRS configuration searches may be implemented as part of an OTDOA or like positioning session, such as in connection with a location server via an exchange of messages, though claimed subject matter is not so limited. In some instances, messages may include one or more communication sequences regarding capability exchange and/or transfer, assistance data exchange and/or transfer, location information transfer, etc., or any combination thereof. As a way of illustration, at times, an OTDOA or like positioning session may include, for example, a session employing Long Term Evolution (LTE) or like technology (e.g., LTE Advanced, etc.), session providing one or more extensions for OTDOA or like positioning, such as an LTE positioning protocol (LPP) LPPe positioning session, though, again, claimed subject matter is not so limited. It should be noted that even though the discussion throughout the specification primarily references particular signals, protocols, and/or networks, such as, for example, PRS for OTDOA in 4G Long Term Evolution (LTE), such as for ease of description, any other suitable signals, protocols, and/or networks, such as 1× signals for Advanced Forward Link Trilateration (AFLT) in Code Division Multiple Access (CDMA), enhanced Cell ID (E-CID), and/or Wi-Fi positioning (e.g., based on downlink signals according to IEEE 802.11x standards, etc.), positioning for short range nodes (SRNs), such as Bluetooth® Low Energy (BTLE) beacons, satellite positioning system (SPS) signals, or the like may also be utilized herein, in whole or in part, such as in a similar or like fashion and/or without deviating from the scope of claimed subject matter.

As used herein, “mobile communication device,” “location-aware mobile device,” or like terms may be used interchangeably and refer to any kind of special purpose computing platform and/or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map generation tools, or the like. It should be appreciated, however, that these are merely examples of mobile devices that may be used, at least in part, to implement one or more operations and/or techniques for targeted PRS configuration searches, and that claimed subject matter is not limited in this regard. It should also be noted that the terms “position” and “location” may be used interchangeably herein.

As alluded to previously, at times, a position fix of a mobile device, such as a cellular telephone, for example, may be obtained based, at least in part, on information gathered from various systems. As was also indicated, one such system may comprise, for example, an OTDOA positioning system. In this system, a server may facilitate and/or support positioning of a mobile device by providing positioning assistance data as well as computing and/or verifying (e.g., if computed at a mobile device, etc.) a position fix using one or more specific signals, referred to as reference signals. Namely, a mobile device may, for example, measure a time difference between reference signals received from a reference wireless transmitter and one or more neighbor wireless transmitters positioned at known locations. In this context, a “wireless transmitter” refers to any suitable device capable of transmitting and/or receiving wireless signals, such as via an integrated or associated receiver and/or transmitter, for example. As a way of illustration, a wireless transmitter may comprise, for example, a cellular base station, wireless local area network (WLAN) access point, radio beacon, femtocell, picocell, or the like. A mobile device may then compute its position fix, such as using obtained measurements or, optionally or alternatively, may report these measurements to a suitable location server, such as, for example, an Enhanced Serving Mobile Location Center (E-SMLC), a Secure User Plane Location (SUPL) Location Platform (SLP), or the like. In turn, with knowledge of locations of measured wireless transmitters, an E-SMLC, SUPL, or like server may, for example, compute a position fix of a mobile device using measured time differences and relative transmission timing, such as via one or more appropriate multilateration techniques, and may communicate the computed position fix to a mobile device of interest.

As was also indicated, at times, one or more operations and/or techniques for targeted PRS configuration searches may also be implemented, at least in part, in connection with one or more other positioning approaches, such as those utilizing measurements of time differences of signals received from a number of wireless transmitters, for example. Thus, in some instances, one or more operations and/or techniques discussed herein may be utilized, at least in part, in connection with, for example, AFLT used for locating a mobile device on a CDMA2000 network, as defined by the 3rd Generation Partnership Project 2 (3GPP2). Similarly to OTDOA, AFLT positioning may, for example, make use of information for measured wireless transmitters to help a mobile device to acquire and/or measure applicable reference signals for purposes of computing a position fix based, at least in part, on these measurements. Depending on an implementation, information may include, for example, locations (e.g., coordinates, etc.), transmission characteristics (e.g., timing, power, signal content, signal characteristics, etc.) of measured wireless transmitters, such as referred to as an almanac, a base station almanac (BSA), almanac data or BSA data, etc. Thus, at times, observed time differences measured by a mobile device (e.g., in connection with OTDOA, AFLT, etc.) may, for example, be used, at least in part, in conjunction with a BSA for measured wireless transmitters to calculate a position fix of a mobile device, such as at or by a location server (e.g., an E-SMLC, SLP, etc.), mobile device, or any combination thereof.

Continuing with the above discussion, to facilitate and/or support one or more operations and/or techniques for targeted PRS configuration searches, one or more wireless transmitters on a network may broadcast a PRS that may be distinct from one or more PRS broadcasted by other nearby wireless transmitters due, at least in part, to a use of a different frequency, different encoding, different times of transmission, or the like. A mobile device may measure PRS transmitted by a reference wireless transmitter and a nearby wireless transmitter and may obtain, for example, a time of arrival (TOA) and/or a reference signal time difference (RSTD) measurement. In this context, “RSTD” refers to one or more measurements indicative of a difference in time of arrival between a PRS transmitted by a measured wireless transmitter, referred to herein as a “neighbor wireless transmitter,” and a PRS transmitted by a reference wireless transmitter. A reference wireless transmitter may be selected by a location server (e.g., an E-SMLC, SLP, etc.), mobile device, or a combination thereof so as to provide good or otherwise sufficient signal strength observed at a receiver of the mobile device, such that a PRS can be more accurately and/or more quickly acquired and/or measured, such as without any special assistance from a serving network, for example.

At times, such as during an LTE Positioning Protocol (LPP) session, as one possible example, a mobile device may be provided with positioning assistance data by a serving network (e.g., by a location server, etc.) to assist in a PRS acquisition and/or measurement, as was also indicated. For example, at times, a location server may provide to a mobile device of interest OTDOA assistance data listing one or more neighbor wireless transmitters capable of transmitting a PRS, which may include identities, center frequencies, etc. of wireless transmitters, their expected RSTD, expected RSTD uncertainty, or the like. Assistance data may also include, for example, an identity of a reference wireless transmitter, frequency for a reference PRS signal, reference PRS code sequence, reference PRS transmission times, PRS configuration, or the like. For example, in some instances, a PRS configuration may comprise one or more parameters, such as PRS bandwidth, PRS subframe offset for a start of applicable PRS occasions, PRS configuration index, number of consecutive subframes, PRS muting pattern, etc. In some instances, assistance data may also specify one or more Quality of Service (QoS) parameters, which may also be used, at least in part, in connection with searching a PRS and/or measuring RSTD. For example, in some instances, a QoS parameter may comprise a response time for measuring TOA and/or providing RSTD measurements to a location server and which a mobile device and/or server may take into account, such as during an OTDOA or like positioning session, as one possible example.

A mobile device may then typically measure a PRS (e.g., a TOA for a PRS, etc.) for one or more neighbor wireless transmitters, such as by integrating a received signal at a neighbor wireless transmitter carrier frequency, for example, in accordance with provided assistance data (e.g., a PRS configuration, etc.) and a QoS parameter (e.g., a maximum response time, etc.). For example, based, at least in part, on received assistance data and/or a QoS parameter, a mobile device may be capable of determining a number of neighbor wireless transmitters to be searched (e.g., for acquisition of a PRS, etc.) in an effective and/or efficient manner, an order and/or duration of a particular PRS search, dynamic time frame for responding with RSTD measurements, whether greater accuracy or faster time-to-first fix (TTFF) is desired for an optimum or otherwise suitable position fix, or the like. Having measured PRS, a mobile device may perform RSTD measurements, such as utilizing provided assistance data, for example, and may report RSTD measurements to a location server, such as prior to expiration of a maximum response time specified by the server via a QoS parameter.

Unfortunately, in some instances, one or more parameters provided to mobile devices for searching PRS by a location server as part of positioning assistance data, such as parameters indicative of one or more PRS configurations, for example, may be inaccurate, outdated, missing, etc., which may increase a TTFF, introduce RSTD measurement errors, or otherwise negatively affect OTDOA or like positioning. For example, at times, a mobile device may communicate with a proprietary location server that is not operated by a particular network (e.g., an LTE network, etc.) to obtain positioning assistance data, which may include parameters indicative of one or more PRS configurations of proximate wireless transmitters. While a proprietary server may not have access to particular PRS configuration parameters maintained by a carrier (e.g., an LTE carrier, etc.), in some instances, it may be possible for the proprietary server to obtain PRS configurations based, at least in part, on observations obtained from mobile devices operating in a coverage area of the carrier. In this context, “observation” refers to a measured attribute and/or characteristic of a wireless signal transmitted by a wireless transmitter and acquired by an observing receiver at a mobile device. One or more attributes and/or characteristics of a wireless signal may, for example be measured in connection with a performing a scan of an area of interest, such as a passive scan and/or active scan, or any combination thereof, and/or encoding, modulating, demodulating, decoding, etc. one or more properties of an appropriate wireless signal.

As a way of illustration, an active scan may, for example, be performed via transmitting one or more requests, such as in the form of one or more unicast packets and receiving one or more responses from one or more proximate wireless transmitters, and a passive scan may, for example, be performed by “listening” for or discovering wireless signals broadcasted by proximate wireless transmitters. Passive and active scans are generally known and need not be described here in greater detail. An observation may include, for example, one or more identifiers of wireless transmitters, such as cellular identifications (Cell IDs), basic service set identifications (BSS IDs), service set identifications (SS IDs), etc., characteristics of wireless signals (e.g., received signal strength, round trip time, time of arrival, angle of arrival, transmission power levels, etc.), PRS configuration parameters (e.g., PRS bandwidth, PRS configuration index, number of successive subframes, PRS muting pattern, etc.), or the like.

At times, indiscriminate collection of observations of wireless signals indicative of one or more PRS configurations at mobile devices, however, may strain available uplink messaging resources, tax bandwidth in applicable wireless communication links, or the like. Also, in some instances, obtaining observations of particular PRS configurations at a mobile device may unnecessarily expend its battery resources, particularly if parameters indicative of the PRS configurations have already been determined by a location server, for example. At times, this may also increase cellular data usage, associated costs or data charges, or the like. Accordingly, it may be desirable to develop one or more methods, systems, and/or apparatuses that may implement a targeted search of one or more parameters indicative of one or more PRS configurations, such as PRS bandwidth, PRS configuration index, number of successive subframes, PRS muting pattern, etc., for example, via utilization of candidate PRS configurations provided by a location server.

Thus, as will be discussed in greater detail below, in an implementation, a location server, which may include a proprietary location server not operated by a particular carrier, such as an LTE carrier network, as one possible example, may from time to time transmit first messages to mobile devices located within an area of interest specifying parameters indicative of one or more candidate PRS configurations of one or more wireless transmitters expected to be in the area. First messages to mobile devices may, for example, command and/or specify that one or more observations of signals indicative of one or more PRS configurations are to be obtained, a time within which one or more observations are to be obtained, geographic area within which one or more PRS configurations are to be obtained, particular wireless transmitters to be observed, specific PRS parameters to be utilized, or the like, or any combination thereof. Mobile devices may then obtain one or more observations from one or more proximate wireless transmitters utilizing specified PRS configurations, and may transmit to a location server second messages comprising obtained observations. A location server may then incorporate received observations of parameters provided in second messages into positioning assistance data, such as to facilitate and/or support subsequent OTDOA or like positioning within such an area, for example.

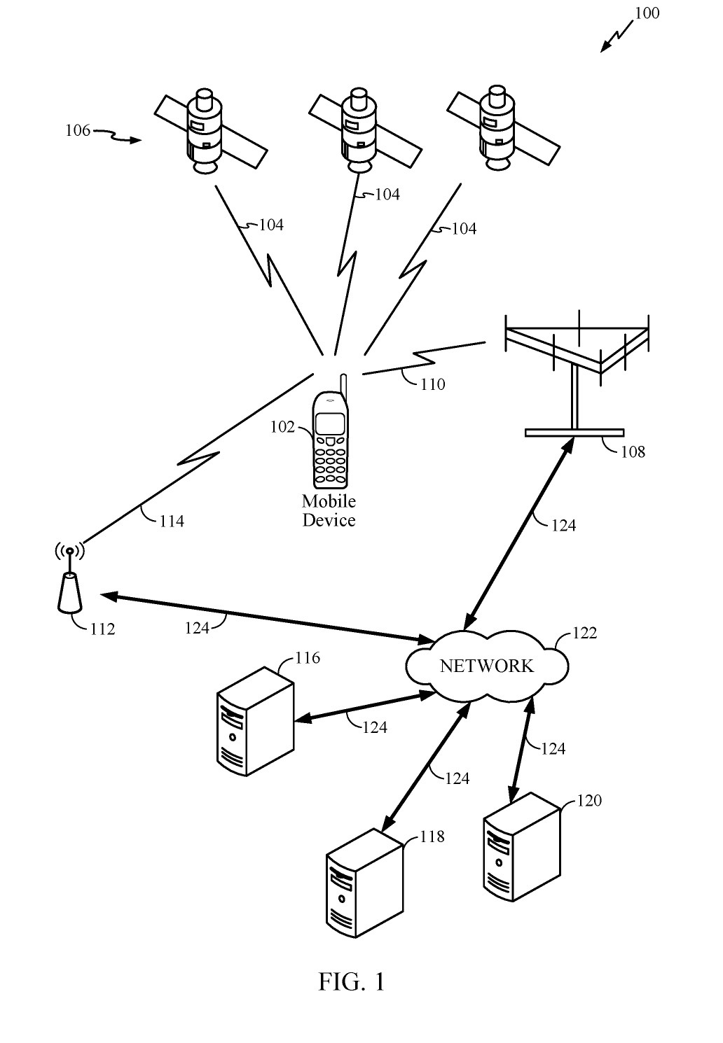

FIG. 1 is a schematic diagram illustrating features associated with an implementation of an example operating environment 100 capable of facilitating and/or supporting one or more processes and/or operations for targeted PRS configuration searches for use in or with a mobile device, such as a location-aware mobile device 102, for example. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), WWAN, wireless local area networks (WLAN, etc.), or the like. It should also be noted that claimed subject matter is not limited to indoor implementations. For example, at times, one or more operations and/or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations and/or techniques described herein may be performed, at least in part, in an outdoor environment.

As illustrated, in an implementation, mobile device 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems. In certain implementations, SPS satellites 106 may be from any one several regional navigation satellite systems (RNSS) such as, for example, WAAS, EGNOS, QZSS, just to name a few examples.

At times, mobile device 102 may, for example, transmit wireless signals to, or receive wireless signals from, a suitable wireless communication network. In one example, mobile device 102 may communicate with a cellular communication network, such as by transmitting wireless signals to, or receiving wireless signals from, one or more wireless transmitters capable of transmitting and/or receiving wireless signals, such as a base station transceiver 108 over a wireless communication link 110, for example. Similarly, mobile device 102 may transmit wireless signals to, or receive wireless signals from a local transceiver 112 over a wireless communication link 114. Base station transceiver 108, local transceiver 112, etc. may be of the same or similar type, for example, or may represent different types of devices, such as access points, radio beacons, cellular base stations, femtocells, or the like, depending on an implementation. Similarly, local transceiver 112 may comprise, for example, a wireless transmitter and/or receiver capable of transmitting and/or receiving wireless signals. For example, as will be seen, at times, wireless transceiver 112 may be capable of obtaining one or more observations from one or more other terrestrial transmitters.

In a particular implementation, local transceiver 112 may be capable of communicating with mobile device 102 at a shorter range over wireless communication link 114 than at a range established via base station transceiver 108 over wireless communication link 110. For example, local transceiver 112 may be positioned in an indoor or like environment and may provide access to a wireless local area network (WLAN, e.g., IEEE Std. 802.11 network, etc.) or wireless personal area network (WPAN, e.g., Bluetooth® network, etc.). In another example implementation, local transceiver 112 may comprise a femtocell or picocell capable of facilitating communication via link 114 according to an applicable cellular or like wireless communication protocol. Of course, it should be understood that these are merely examples of networks that may communicate with mobile device 102 over a wireless link, and claimed subject matter is not limited in this respect. For example, in some instances, operating environment 100 may include a larger number of base station transceivers 108, local transceivers 112, etc.

In an implementation, base station transceiver 108, local transceiver 112, etc. may communicate with servers 116, 118, or 120 over a network 122 via one or more links 124. Network 122 may comprise, for example, any combination of wired or wireless communication links. In a particular implementation, network 122 may comprise, for example, Internet Protocol (IP)-type infrastructure capable of facilitating or supporting communication between mobile device 102 and one or more servers 116, 118, 120, etc. via local transceiver 112, base station transceiver 108, etc. In another implementation, network 122 may comprise, for example cellular communication network infrastructure, such as a base station controller or master switching center to facilitate and/or support mobile cellular communication with mobile device 102. As was indicated, in some instances, network 122 may facilitate and/or support communications with a PSAP (not shown) or like entity, such as for purposes of initiating and/or implementing an E911 OTDOA positioning session, for example, if applicable. Servers 116, 118, and/or 120 may comprise any suitable servers or combination thereof capable of facilitating or supporting one or more operations and/or techniques discussed herein. For example, servers 116, 118, and/or 120 may comprise one or more location servers (e.g., Evolved Serving Mobile Location Server (E-SMLC), Secure User Plane Location Server/SUPL Location Platform (SUPL SLP), etc.), positioning assistance servers, navigation servers, map servers, crowdsourcing servers, network-related servers, or the like.

In particular implementations, and as also discussed below, mobile device 102 may have circuitry or processing resources capable of determining a position fix or estimated location of mobile device 102, initial (e.g., a priori) or otherwise. For example, if satellite signals 104 are available, mobile device 102 may compute a position fix based, at least in part, on pseudorange measurements to four or more SPS satellites 106. Here, mobile device 102 may compute such pseudorange measurements based, at least in part, on pseudonoise code phase detections in signals 104 acquired from four or more SPS satellites 106. In particular implementations, mobile device 102 may receive from one or more servers 116, 118, or 120 positioning assistance data to aid in the acquisition of signals 104 transmitted by SPS satellites 106 including, for example, almanac, ephemeris data, Doppler search windows, just to name a few examples.

In some implementations, mobile device 102 may obtain a position fix by processing wireless signals received from one or more terrestrial transmitters positioned at known locations (e.g., base station transceiver 108, local transceiver 112, etc.) using any one of several techniques, such as, for example, OTDOA, AFLT, or the like. In these techniques, a range from mobile device 102 may, for example, be measured to three or more of terrestrial transmitters based, at least in part, on one or more reference signals (e.g., PRS, etc.) transmitted by these transmitters and received at mobile device 102, as was indicated. Here, servers 116, 118, or 120 may be capable of providing positioning assistance data to mobile device 102 including, for example, OTDOA reference transmitter data, OTDOA neighbor transmitter data, RSTD search window, QoS parameters, PRS configuration parameters, candidate or otherwise, locations, identities, orientations, etc. of terrestrial transmitters to facilitate and/or support one or more applicable positioning techniques (e.g., AFLT, OTDOA, etc.). At times, servers 116, 118, or 120 may include, for example, a base station almanac (BSA) indicating locations, identities, orientations, etc. of cellular base stations (e.g., base station transceiver 108, local transceiver 112, etc.) in one or more particular areas or regions associated with operating environment 100.

As alluded to previously, in particular environments, such as indoor or like environments (e.g., urban canyons, etc.), mobile device 102 may not be capable of acquiring and/or processing signals 104 from a sufficient number of SPS satellites 106 so as to perform a suitable positioning technique. Thus, optionally or alternatively, mobile device 102 may be capable of determining a position fix based, at least in part, on signals acquired from one or more local transmitters, such as femtocells, Wi-Fi access points, or the like. For example, mobile device 102 may obtain a position fix by measuring ranges to three or more local transceivers 112 positioned at known locations. In some implementations, mobile device 102 may, for example, measure ranges by obtaining a MAC address from local transceiver 112, as was indicated.

In an implementation, mobile device 102 may, for example, receive positioning assistance data (e.g., OTDOA, AFLT assistance data, etc.) for one or more positioning operations from servers 116, 118, and/or 120. At times, positioning assistance data may include, for example, locations, identities, orientations, PRS configurations, etc. of one or more local transceivers 112, base station transceivers 108, etc. positioned at known locations for measuring ranges to these transmitters based, at least in part, on an RTT, TOA, TDOA, etc., or any combination thereof. In some instances, positioning assistance data to aid indoor positioning operations may include, for example, radio heat maps, context parameter maps, routeability graphs, etc., just to name a few examples. Other assistance data received by mobile device 102 may include, for example, electronic digital maps of indoor or like areas for display or to aid in navigation. A map may be provided to mobile device 102 as it enters a particular area, for example, and may show applicable features such as doors, hallways, entry ways, walls, etc., points of interest, such as bathrooms, pay phones, room names, stores, or the like. By obtaining a digital map of an indoor or like area of interest, mobile device 102 may, for example, be capable of overlaying its current location over the displayed map of the area so as to provide an associated user with additional context, frame of reference, or the like. The terms “positioning assistance data” and “navigation assistance data” may be used interchangeably herein.

According to an implementation, mobile device 102 may access navigation assistance data via servers 116, 118, and/or 120 by, for example, requesting such data through selection of a universal resource locator (URL). In particular implementations, servers 116, 118, and/or 120 may be capable of providing navigation assistance data to cover many different areas including, for example, floors of buildings, wings of hospitals, terminals at an airport, portions of a university campus, areas of a large shopping mall, etc., just to name a few examples. Also, if memory or data transmission resources at mobile device 102 make receipt of positioning assistance data for all areas served by servers 116, 118, and/or 120 impractical or infeasible, a request for such data from mobile device 102 may, for example, indicate a rough or course estimate of a location of mobile device 102. Mobile device 102 may then be provided navigation assistance data covering, for example, one or more areas including or proximate to a roughly estimated location of mobile device 102. In some instances, one or more servers 116, 118, and/or 120 may facilitate and/or support searching for and/or measuring PRS from one or more applicable wireless transmitters (e.g., local transceiver 112, base station transceiver 108, etc.) and/or performing RSTD or like measurements, such as for determining a position fix in connection with an OTDOA or like positioning session, for example, and may provide the position fix to mobile device 102.

Even though a certain number of computing platforms and/or devices are illustrated herein, any number of suitable computing platforms and/or devices may be implemented to facilitate and/or support one or more techniques and/or processes associated with operating environment 100. For example, at times, network 122 may be coupled to one or more wired or wireless communication networks (e.g., WLAN, etc.) so as to enhance a coverage area for communications with mobile device 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

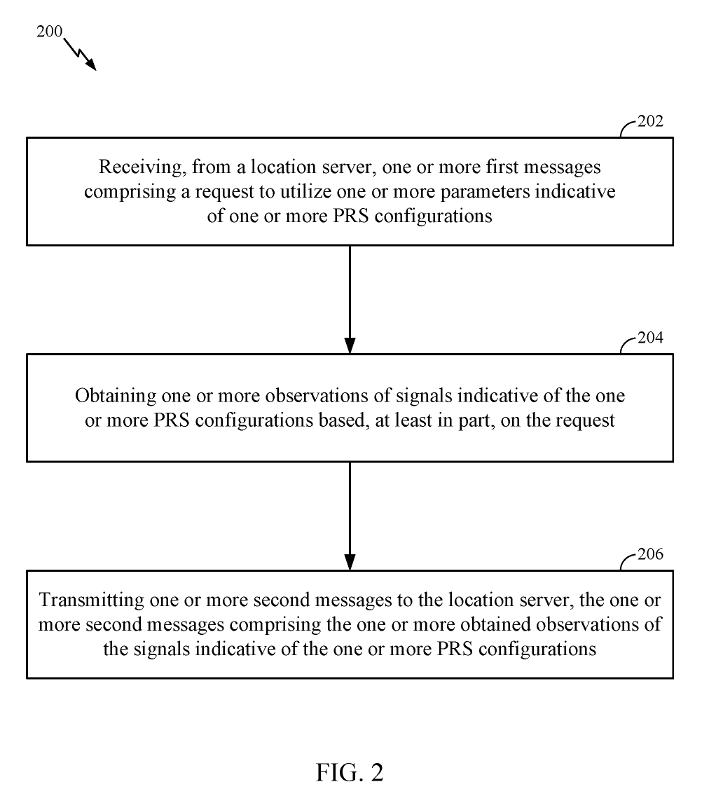

With this in mind, attention is now drawn to FIG. 2, which is a flow diagram illustrating an implementation of an example process 200 that may be performed, in whole or in part, to facilitate and/or support one or more operations and/or techniques for targeted PRS configuration searches. As was indicated, at times, process 200 may be implemented, at least in part, via a location-aware mobile device, such as, for example, mobile device 102 of FIG. 1, though claimed subject matter is not so limited. For example, in some instances, one or more operations of process 200 may be implemented, at least in part, via a server device, such as one or more servers 116, 118, and/or 120 of FIG. 1, or any combination of a server device and a mobile device. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

It should be noted that, depending on an implementation, process 200 may, for example, be implemented, in whole or in part, in connection with any suitable communication and/or positioning protocol. For example, at times, process 200 may be implemented, at least in part, in connection with OTDOA positioning using a Long Term Evolution (LTE) positioning protocol (LPP), though, again, claimed subject matter is not limited in this regard. In some instances, an LPPe, LPP/LPPe, RRC protocol (e.g., as defined in 3GPP TS 36.331, etc.), IS-801 protocol (e.g., as defined in 3GPP2 TS C.S0022, etc.), or the like may also be employed herein, in whole or in part. Thus, at times, one or more operations and/or techniques for targeted PRS configuration searches may, for example, be implemented in connection with OTDOA positioning for UMTS access, Enhanced Observed Time Difference (E-OTD) for GSM or AFLT, or the like. In addition, a downlink signal that is measured by mobile device 202 may not be a PRS, such as currently defined in 3GPP, but some other downlink reference signal or pilot signal (e.g., a common reference signal (CRS) for LTE, etc.). In addition, measurements of a downlink signal may not be of RSTD, such as also defined by 3GPP, for example, but instead of some other suitable quantity and/or phenomena, such as TOA, angle of arrival (AOA), received signal strength (e.g., RSSI), return trip time (RTT), signal-to-noise (S/N) ratio (SNR), or the like. Thus, although one or more applicable positioning techniques, protocols, measured quantities, etc. may differ, a search strategy with respect to acquisition of one or more downlink reference signals and/or pilot signals, such as via a targeted PRS configuration search, as discussed below, for example, may be the same as or similar to that described for process 200.

Thus, example process 200 may, for example, begin at operation 202 with receiving, from a location server, one or more first messages comprising a request to utilize one or more parameters indicative of one or more PRS configurations. As discussed below, one or more first messages may comprise, for example, one or more particular candidate PRS configurations defined by a location server for a mobile device to test or measure, such as for purposes of confirming or invalidating the candidate PRS configurations. For example, one or more candidate PRS parameters to confirm or invalidate may comprise PRS bandwidth, PRS configuration index I_{PRS} conveying a subframe offset for a start of PRS occasions and their periodicity T_{PRS}, number of successive or consecutive subframes N_{PRS}, and/or PRS muting pattern. At times, one or more parameters indicative of one or more PRS configurations, such as a cyclic prefix (CP) type, number of transmitter (TX) antennas on a transmitting device, etc. may not be transmitted by a location server, such as for purposes of confirming or invalidating, for example, but instead may be known to and/or determined by a mobile device, such as via one or more applicable demodulation procedures or processes, as will also be seen. In some instances, parameters indicative of one or more PRS configurations may, for example, be randomly selected for and/or communicated to a number of different mobile devices, which may depend, at least in part, on a particular geographic area, mobile device, wireless environment, application, or the like.

In some instances, one or more first messages comprising a request may, for example, specify a particular time for initiating a process of obtaining one or more observations of signals indicative of one or more PRS configurations, such as via an appropriate informational element (IE) that may be embedded in a suitable data structure within the request. A particular non-limiting example of a data structure that may comprise one or more first messages will be described in greater detail below with reference to Table 1. Thus, a mobile device may initiate a process of obtaining one or more observations of signals indicative of one or more PRS configurations using a specified time, as also discussed below. It should be noted that such a specified time may, for example, be reset, such as if a new message comprising a request to utilize one or more parameters indicative of one or more PRS configurations is received. Thus, at times, one particular measurement set comprising one or more PRS configurations may, for example, be obtained per one request, though claimed subject matter is not so limited. In some instances, a specified time may comprise, for example, a random time (e.g., initiate a process anytime between 0 to 16 hours from receipt of a request, etc.), just to illustrate one possible implementation. Again, claimed subject matter is not so limited.

For purposes of explanation, in LTE, a PRS is typically transmitted via a number of pre-defined LTE positioning subframes grouped via several consecutive subframes or so-called sets. A set of consecutive LTE subframes in which a PRS is transmitted is referred to as a PRS positioning occasion. In a typical LPP positioning session, a PRS positioning occasion comprises between one and six consecutive subframes. Thus, by way of example but not limitation, one possible approach or strategy for searching and/or determining PRS configurations may include the following. For example, first, N_{PRS} may be determined. Here, such a determination my involve utilization, at least initially, of PRS bandwidth (BW) of 1.4 MHz and N_{PRS}=1. As such, this BW may, for example, be provided to a mobile device in one or more first messages as a fixed parameter, such as for purposes of confirming or invalidating. Based, at least in part, on N_{PRS}, I_{PRS} may, for example, be determined. Typically, although not necessarily, I_{PRS} may be the same or similar for much of a wireless network and, as such, may be determined relatively quickly using a sufficient number of responses from participating mobile devices. After that, PRS BW, with I_{PRS}, and a PRS muting pattern may, for example, be determined, such as discussed below. Of course, claimed subject matter is not limited to a particular approach or strategy.

Thus, in a particular implementation, one or more first messages comprising a request to utilize one or more parameters indicative of one or more PRS configurations may, for example, specify that one or more observations of signals indicative of one or more PRS configurations are to be obtained, a time for initiating a process of obtaining one or more observations, a particular wireless transmitter to be observed, specific PRS parameters to be utilized (e.g., for confirmation or invalidation, etc), etc. or any combination thereof. In some instances, a measurement attempt by a mobile device (e.g., of obtaining one or more PRS configurations, etc.) may be triggered by meeting a particular threshold, for example, which may also be communicated to a mobile device by a location server in one or more first messages. Depending on an implementation, such a threshold may be based, at least in part, on signal strength (SS), signal-to-noise ratio (SNR), or like phenomena with respect to observed wireless signals. Such a threshold may be determined, at least in part, experimentally and may be pre-defined or configured, for example, or otherwise dynamically defined in some manner depending on a wireless environment, mobile device, application, or the like. Although claimed subject matter is not limited in this regard, to illustrate, an SNR threshold of around 10.0 dB to 15.0 dB and/or a signal strength threshold of minus 130.0 dbm/15.0 KHz or greater may prove beneficial for purposes of initiating a process of obtaining one or more observations of signals indicative of one or more PRS configurations.

Continuing with the above discussion, by way of example but not limitation, in one particular simulation or experiment, one or more request parameters indicative of one or more PRS configurations included those illustrated in Table 1 below, though claimed subject matter is not so limited. It should be noted that, in some instances, a request to utilize one or more parameters indicative of one or more PRS configurations may be tailored to particular wireless transmitter, such as a serving wireless transmitter, for example. In this context, a “serving” wireless transmitter refers to a primary wireless transmitter, such as operating on a primary frequency, or a set of wireless transmitters comprising a primary wireless transmitter and one or more secondary wireless transmitters, such as operating on a secondary frequency (e.g., once a radio resource control (RRC) connection is established, etc.). As discussed below, in at least one implementation, a serving wireless transmitter may comprise, for example, a serving cellular base station or so-called serving “cell,” though, again, claimed subject matter is not so limited. For example, depending on an implementation, a serving wireless transmitter may comprise, for example, a WLAN access point, local wireless transmitter, femtocell, or the like.

Thus, consider, for example:

TABLE 1
Example request parameters.

| Description | | Range | Bits |
|---|---|---|---|
| Modes | | Bit flags | 4 |
| Bit 1:0 - 0 = Normal Meas, 1 = PRS BW Meas, 2 and 3 Reserved | | | |
| 0) | Normal Meas: Perform PRS measurements according to | | |
| | the parameters below. There is no change in parameters | | |
| | between consecutive measurement occasions. | | |
| 1) | PRS BW Meas: Obtain observations from lowest | | |
| | 1.4 MHz BW up thru the PRS BW specified. This will | | |
| | result in a maximum of 6 sets of measurements, one | | |
| | for each BW. The maximum is set by min(Specified | | |
| | PRS BW in this protocol, System BW for the Cell as | | |
| | decoded by UE) | | |
| 2) | Reserved: Iprs Meas (cycle thru Iprs from starting Iprs | | |
| | in increasing Iprs at each subsequent occasion) | | |
| 3) | Reserved | | |
| Bit 2 - 0 = Non-cell Specific Meas, 1 = Cell Specific Meas | | | |
| 0) | Non-cell Specific Meas: Obtain observations from | | |
| | “any” cell | | |
| 1) | Cell Specific Meas: Obtain observations from “only” | | |
| | the cell(s) satisfying parameters specified in this | | |
| | command packet | | |

| | | |
|---|---|---|
| Bit 3 - Reserved, set to 0 to ensure future compatibility | | |
| PRS BW | 6 possibilities | 3 |
| If Normal Meas mode, contains the PRS BW to measure | | |
| If PRS BW Meas mode, contains the max PRS BW to measure. | | |
| But actual max will be min(Max PRS BW specified, System BW) | | |
| Iprs (or starting Iprs, if Iprs Meas mode) | 0-2399 | 12 |
| | 2400-4095 | |
| | (reserved range) | |
| Cell to Measure | MCC | 16 bytes × 8 |
| If Cell Specific Meas is set, then “only” measure for cell(s) | MNC | bits/byte |
| satisfying these parameterseither in Normal or PRS BW Meas mode. | TAG | |
| A parameter not included is considered a “don't care.” | Cell ID | |
| | EARFCN | |
| If Non-cell Specific Meas in the Modes field, this field is “not” | | |
| included | | |
| Max number of measurement sets | Optional | Optional |

Here, as was indicated, BW denotes PRS bandwidth, MCC denotes a mobile country code, MNC denotes a mobile network code, TAC denotes a tracking area code, Cell ID denotes a cellular identification, and EARFCN denotes evolved universal terrestrial radio access (EUTRA) absolute radio frequency channel number. These or like aspects or features are generally known and need not be described here in greater detail.

Thus, for this example, T_{PRS} may be determined based, at least in part, on I_{PRS}, such as defined via a 3GPP standard, for example. In some instances, this parameter may, for example, be considered as optional, meaning that, at times, it may not be required or otherwise useful. Likewise, in some instances, N_{PRS} parameter may not be required or otherwise useful, since N_{PRS}=1, as was indicated, meaning that even for initial or pre-set BW of 1.4 MHz, a mobile device may still be capable of detecting of a serving cell. It should also be noted that, at times, a cyclic prefix (CP), a number of TX antennas on a transmitting device, and/or a physical Cell ID (PCI) parameters may not be required or otherwise useful, since these may be determined by a mobile device, such as decoded while the mobile device is “camped” on such a cell. In this context, “camping” on a cell refers to a state of connectivity of a mobile device in which the mobile device is connected and/or tuned to a particular wireless transmitter's control channel, such as for the purposes of area registration, obtaining available wireless services, or the like.

It should be noted that, depending on an implementation, a reference signal received quality (RSRQ) value for a CRS, such as to trigger a measurement attempt of one or more PRS configurations by a mobile device, for example, may or may not be included in one or more first messages. In this context, “RSRQ” refers to an interference-type measure indicative of a quality of a received reference signal computed as RSRQ=(N*RSRP)/RSSI measured over the same bandwidth, where N is a number of resource blocks of a carrier RSSI measurement bandwidth. RSRQ is generally known and need not be described here in greater detail. It should also be noted that inclusion of an RSRQ value into a request may introduce additional complexity into a process, though, since such a value may “gate” or prevent acquisition of lower quality signals in measurement attempts, which may interrupt or otherwise affect the process in the absence of higher quality signals, for example. As also illustrated, a “maximum number of measurement sets” element may be optional in certain example implementations since, in some instances, a single measurement per a mobile device per day may be sufficient, meaning that a PRS configuration may be determined via a few consistent observations per cell.

In some instances, such as if I_{PRS} is not known, for example, a location server may randomly allocate all or most possible I_{PRS} values to mobile devices located within an area of interest, all or most with a lowest or lower PRS BW and normal PRS measurement mode (e.g., with a normal downlink subframe, normal inter-frequency measurements, etc.), and/or a non-specific cell. Since typically, although not necessarily, a wireless network may contain a few different I_{PRS} values, these may be relatively quickly obtained from obtained observations. Further, for I_{PRS} measurement mode, if applicable, a mobile device may go through multiple sets of candidate I_{PRS}, such as starting from a specified I_{PRS}, and incrementing one I_{PRS} on each successive measurement attempt, which may facilitate and/or support relatively faster I_{PRS} search and/or validation. For this particular example, since a maximum memory, as currently defined in a request, is for 6 sets of 16 successive occasions, a number of measurements may be limited, such as either implicitly by a process (e.g., a mobile device's memory, which is currently set to 6 sets, etc.) or, optionally or alternatively, explicitly by inclusion of a corresponding instruction or IE into a request. Here, for purposes of instructions (e.g., encoding, etc.), Abstract Syntax Notation One (ASN.1) or like protocol may be used, at least in part, or otherwise considered, though claimed subject matter is not so limited.

With regard to operation, 204, one or more observations of signals indicative of the one or more PRS configurations may, for example, be obtained based, at least in part, on the request. As was indicated, a mobile device, while located in an area of interest, may observe wireless signals, such as at an associated receiver, for example, and may decode, demodulate, etc. the signals to obtain one or more request-related parameters. As was also discussed, a mobile device may, for example, utilize a communicated request to determine when and/or whether to initiate a process of obtaining one or more observations of signals indicative of one or more PRS configurations. For example, a request may comprise an IE or like element specifying a time for initiating a measurement attempt with respect to one or more PRS configurations, among other parameters, such as discussed above.

As a general approach, with respect to obtaining one or more observations of signals indicative of one or more PRS configurations, in some instances, it may be useful to meet the following criteria:

A time specified for initiating or attempting measurements of one or more PRS configurations may need to be elapsed or exceeded.

A mobile device should not be in an E911 positioning session. Thus, in some instances, such as if a mobile device is in the process of obtaining one or more observations while an E911 call is initiated, such a process should be interrupted or stopped, and associated resources should be re-designated to facilitate and/or support an on-going E911 positioning session. A measurement set with PRS configurations that was not completed prior to a 911 call, may be updated or completed afterwards, such as if one or more appropriate conditions, as discussed herein, are satisfied, for example, or, optionally or alternatively, an incomplete measurement set may be discarded.

A mobile device may need to be camped on a cell, such as discussed above.

If one or more observations are being obtained while in a cell-specific measurement mode, discussed below, a mobile device may need to be camped on a cell specified by a location server (e.g., via a request, etc.). Of course, these particular criteria are merely examples to which claimed subject matter is not limited.

According to an implementation, if a connection with a serving cell, while obtaining one or more observations (e.g., during any portion of collecting 16 occasions, etc.), is lost, an incomplete measurement set may, for example, be deleted, and a process of obtaining one or more observations of signals indicative of one or more PRS configurations may be stared anew, such as once a connection is re-established. This may facilitate and/or support obtaining a full or complete set of measurements that is closer in time, which may be beneficial.

Continuing with the above discussion, in some instances, one or more PRS configurations for responding to a request to utilize one or more parameters indicative of one or more PRS configurations, such as obtained via observing wireless signals within an area of interest, for example, may mirror to some extent one or more PRS configurations provided by a location server in one or more first messages. Thus, in one particular simulation or experiment, response parameters, such as obtained via one or more observations of signals indicative of one or more PRS configurations, for example, may comprise those illustrated in Table 2 below. Thus, consider:

TABLE 2
Example response parameters.

| Description | | Range | Bits |
|---|---|---|---|
| Modes | | Bit flags | 4 |
| Bit 1:0 - 0 = Normal Meas, 1 = PRS BW Meas, 2 and3 Reserved | | | |
| 0) | Normal Meas: Perform PRS measurements according to | | |
| | the parameters below. There is no change in parameters | | |
| | between consecutive measurement occasions. | | |
| 1) | PRS BW Meas: Obtain observations from lowest | | |
| | 1.4 MHz BW up thru the PRS BW specified. This will | | |
| | result in a maximum of 6 sets of measurements, one | | |
| | for each BW. The maximum is set by min(Specified | | |
| | PRS BW in this protocol, System BW for the Cell as | | |
| | decoded by UE) | | |
| 2) | Reserved: Iprs Meas (cycle thru Iprs from starting | | |
| | Iprs in increasing Iprs at each subsequent occasion) | | |
| 3) | Reserved | | |
| Bit 2 - 0 = Non-cell Specific Meas, 1 = Cell Specific Meas | | | |
| 0) | Non-cell Specific Meas: Obtain observations from | | |
| | “any” cell | | |
| 1) | Cell Specific Meas: Obtain observations from “only” | | |
| | the cell(s) satisfying parameters specified in this | | |
| | command packet | | |

| | | |
|---|---|---|
| Bit 3 - Reserved, set to 0 to ensure future compatibility | | |
| PRS BW | 6 possibilities | 3 |
| If Normal Meas mode, contains the PRS BW measured | | |
| If PRS BW Meas mode, contains the max PRS BW measured | | |
| Iprs (or starting Iprs, if Iprs Meas mode) | 0-2399 | 12 |
| | 2400-4095 | |
| | (reserved range) | |
| CP (Cyclic Prefix) | 2 possibilities | 1 |
| Num of TX Antennas | 2 possibilities | 1 |
| Cell Measured | MCC | 16 bytes × 8 |
| | MNC | bits/byte |
| | TAC | |
| | Cell ID | |
| | EARFCN | |
| SNR and Main Peak Width | 8 possibilities | 16 occasions/set |
| If Normal Meas, contains 16 consecutive occasion | SNR | 6 sets maximum |
| measurements | | |
| If PRS BW Meas, contains a maximum of 6 sets | 6 BW sets: | For each meas: |
| starting from the lowest BW of 1.4 MHz. PRS BW in | 1.4 MHz; 3 MHz; | 3 bits for SNR |
| this packet specifies the actual maximum BW | 5 MHz; 10 MHz; | 8 bits for Width |
| measured, which determines the number of | 15 MHz; 20 MHz | |
| measurement sets. | | |

Here, “main peak width” or simply “width” refers to a measure of how wide a main correlation peak is in a channel energy response (CER) domain. At times, a width may, for example, be used, at least in part, to determine or infer PRS BW. For example, here, in some instances, a quadratic fit of maximum peak y=A·x²+B·x+C may be used, at least in part, which may be normalized by interpolated max value y/max(y). As such, a normalized A-parameter may provide an indication of a width of such a peak. For ranges of an A-parameter, such as to distinguish signals with different BWs, if applicable, any suitable thresholds may, for example, be used, in whole or in part. Thus, consider:

TABLE 3
Example BWs.

| | SysBW (MHz) | | | | | |
|---|---|---|---|---|---|---|
| | 1.4 | 3 | 5 | 10 | 15 | 20 |
| Effective BW | 1.08 | 2.7 | 4.5 | 9 | 13.5 | 18 |
| (MHz) | | | | | | |
| Null-to-null | 56.9 | 22.8 | 13.7 | 6.8 | 4.6 | 3.4 |
| peak-width | | | | | | |
| (Ts) | | | | | | |
| A-parameter | — | — | — | — | — | — |
| (normalized) | | | | | | |
| typical | 0.0041 | 0.0252 | 0.0688 | 0.2526 | 0.4944 | 0.7262 |

In some instances, quadratic equation parameter estimation for a maximum peak may be used herein, or otherwise considered as, for example:

A=(CER_early+CER_late)/2.0 CER_prompt
B=(CER_early−CER_late)/2.0
C=CER_prompt (e.g., the max sample)
At times, for a quadratic interpolation, it may be useful to have at least three sample points on a peak. Here, an A parameter may, for example, be normalized as:

$${A}_{norm} = \frac{A}{C - \frac{{B}^{2}}{4 \cdot A}}$$

In some instances, it may, for example, also be useful if a max peak is above an SNR threshold, if a peak is not saturated, if Aₙₒᵣₘ is non-positive, and/or if THRESHOLD_high[ij]>A_norm>=THRESHOLD_low[ij]. At times, a list of BW-dependent thresholds may, for example, be utilized, in whole or in part, such as until a match is found. Of course, these are merely details relating to a peak width metric to which claimed subject matter is not limited.

As illustrated, in an implementation, a measurement set may, for example, be defined as 16 consecutive occasions, such as denoted via T_{PRS}. Given presence of a particular muting pattern, it may be useful to obtain 16 consecutive occasions to ensure observing at least one occasion where a cell is transmitting a PRS. As also seen, at times, cyclic prefix and/or a number of TX antennas on a transmitting device may be determined by a mobile device, such as to be included in a response, as discussed below.

Thus, as also seen, in a particular implementation that utilizes normal measurements (e.g., in connection with a typical OTDOA positioning session, etc.), if applicable, 16 consecutive occasions may, for example, be observed, such as starting from I_{PRS} for a location server-specified BW. As such, here, for each occasion, one SNR-Width (S,W) measurement pair may, for example, be obtained. Thus, consider, for example:

In an implementation that utilizes sequential BW measurements, if applicable, all or most BW for PRS in successive 16 occasion sets may, for example, be measured. Thus, consider, for example:

In at least one implementation that utilizes parallel BW measurements, if applicable, all or most BW for PRS in a single occasion may, for example, be measured. Thus, consider, for example:

In some instances, it may be useful to specify an order of SNR-Width pairs, such as to adhere to a particular a protocol or format, for example, even though, at times, only Width may be specified, such as to save on over-the-air (OTA) data bytes, for example. At times, such as for the above examples, SNR for each observation set for each occasion may, for example, be used, but, in some instances, a single Width result may be provided for a particular set (e.g., to save OTA bytes, etc.), which may correspond to observation with the largest SNR.

In some instances, it may, for example, be useful to implement a parallel BW measurement mode, rather than a sequential measurement mode, since a PRS configuration search and/or measurement set is typically completed in 16 occasions. To illustrate, for 6 sets of 16 occasions, such as to obtain complete measurements of parameters indicative of one or more PRS configurations (e.g., for T_{PRS}=160 msec, etc.), for example, it may take 6×2.56 seconds or 15.36 seconds, meaning that 15.36 seconds of camping on a cell to complete a full set of PRS BW measurements may not be sufficient. As such, via a sequential measurement mode, certain measurements may not be reported or transmitted to a location server due, at least in part, to a contiguous nature of a process (e.g., a mobile device starting over and over, etc.). Of course, these are merely details to which claimed subject matter is not limited. For example, in some instances, observations capable of being obtained at a given time period (e.g., one minute, etc.) may be provided, such as to limit power on a mobile device. Also, if a specific occasion cannot be measured, for example, a corresponding observation result may be flagged in a suitable manner (e.g., via a flag, IE, etc.), such as to indicate that the occasion was not measured, as opposed to an observation that was measured but not obtained in a result due, at least in part, to being above a threshold.

Continuing with the above discussion, in a particular implementation, an approach for searching and/or measuring one or more PRS configurations may include an example illustrated below. Thus, consider:

A measurement sequence may, for example, start with a first I_{PRS} (not necessarily a first occasion) within a 10.24 seconds system frame number (SFN) sequence. At times, this may, for example, allow for a more effective and/or more efficient alignment of measurements for participating mobile devices.

All or most measurements may be performed with N_{PRS}=1 due, at least in part, to a sufficient sensitivity of a serving cell, meaning that a higher N_{PRS} value may not be needed or otherwise useful. N_{PRS} may, for example, be determined using different I_{PRS} offsets once I_{PRS} is determined.

All or most measurements may be performed with respect to a serving cell.

If a new request to utilize one or more parameters indicative of one or more PRS configurations is received from a location server, a mobile device may delete any previously collected, but yet to be transmitted, measurements, for example, and may start a new process of obtaining one or more observations of signals indicative of one or more PRS configurations, such as utilizing new parameters. This may, for example, be implemented, at least in part, so as to ensure that more recent PRS configurations are obtained. In some instances, measurements may, for example, be queued in a suitable manner (e.g., on a daily basis, etc.), such as for collection, utilization, transmission, or the like.

For a measurement set, 16 consecutive measurement occasions may be measured since this typically represents a maximum muting pattern.

Only one set of measurements per 16 consecutive occasions may be collected, except for PRS BW sequential mode, which may measure a maximum of 6 consecutive sets. At times, there may, for example, be more than one configuration request and, thus, one set per configuration.

A number of measurement sets to be obtained may be encoded on a mobile device, such as, for example, one set for a normal mode or six sets for a sequential PRS BW measurement mode, if enabled.

For a PRS BW measurement mode, 16×6 results may be needed or otherwise useful, such as regardless of implementing a sequential mode or parallel mode. Namely, for a sequential mode, 16 occasions for each measurement set with 6 of the sets, and for a parallel mode, 6 measurements in one occasion with 16 occasions for the set may be collected.

If a request from a location server to utilize one or more parameters indicative of one or more PRS configurations includes an optional “Maximum Number of Measurement Sets” field, as illustrated in Table 1, a mobile device may obtain a specified maximum number of measurement sets and may refrain from making further measurements, such as to save power, for example. In some instances, one or more subsequent measurements may be attempted after a first measurement set is obtained and/or for new or previously unseen or unobserved cells. It may be useful for a mobile device to have sufficient processing and/or memory resources for obtaining a specified maximum number of measurement sets.

In some instances, a location server may be aware of particular PRS configurations in a coverage region (e.g., previously discovered PRS configurations), for example, and may be unaware of other PRS configurations in the region (e.g., undiscovered PRS configurations). To obtain undiscovered PRS configurations, at times, a cell specific measurement mode may, for example, be implemented, in whole or in part, such as via a request from a location server. Such a mode may, for example, facilitate and/or support targeted searches for one or more PRS configuration parameters, such as a particular muting pattern, for example, in an effective and/or efficient manner by targeting a smaller number of specific cells or class of cells without across-the-board data uploads. For example, a location server may obtain a list of neighbor wireless transmitters for which one or more PRS configuration parameters are missing. To illustrate, observations may, for example, be obtained from all or most cells in a particular tracking area code (TAC) (e.g., if a Cell ID field in a request is not included or marked as “don't care,” etc.), or from all or most cells for a particular MCC and MNC (e.g., if a TAC and/or Cell ID are marked as “don't care,” etc.). A location server may subsequently enable a cell specific measurement mode for a number of mobile devices located in the same tracking area code (TAC) or in a near proximity to such a TAC, such as via one or more first messages. At times, these specific cells may be allocated sequentially to mobile devices in that particular TAC. Here, an IE for “specified time” for initiating the mode may be set to 0 (e.g., not random), and a cell specific check may be performed on a mobile device. For example, a mobile device may check to confirm that an observed cell with one or more previously undiscovered PRS configurations is a serving cell. A mobile device may then obtain one or more observations of signals indicative of one or more PRS configurations with respect to such a cell, such as in the manner discussed above.

At times, a mobile device may implement a number of consecutive measurements, such as if specified via a request to utilize one or more parameters indicative of one or more PRS configurations, for example. To illustrate, for PRS BW measurements of 6 possible BWs, a mobile devices may, for example, measure 6 consecutive occasions each with a different BW setting for a particular serving cell, and may communicate results (e.g., SNR, peak location, etc.) to a location server, which may determine PRS BW. Here, to account for a muting pattern, 6 sets of 16 occasions may be needed or otherwise useful. Further, for N_{PRS} of 4 possible values, a mobile device may, for example, measure 4 consecutive occasions each with a different N_{PRS} setting, such as for proper N_{PRS} determination. In some instances, such as if most or all PRS configuration parameters with the exception of a muting pattern are known, for example, a mobile device may measure 16 consecutive occasions with a specified PRS configuration with respect to a particular serving cell and may report results including a subframe number of one of the occasions. Having received this information from a number of mobile devices, a location server may be capable of determining a muting pattern. Once one or more particular PRS configurations are determined, a location server may, for example, direct a subset of mobile devices to continue periodic or sporadic measurements in a particular geographical area, such as to ensure that previously discovered PRS configurations remain unchanged. If previously discovered PRS configurations change, however, which may be determined via a lack of observations of signals indicative of one or more expected PRS configurations, for example, a location server may restart a process to determine one or more new PRS configurations, such as in a similar fashion.

At operation 206, one or more second messages may, for example, be transmitted to the location server, the one or more second messages comprising the one or more obtained observations of the signals indicative of the one or more PRS configurations. Here, any suitable communication protocol may, for example, be utilized, in whole or in part. For example, as was indicated, at times, one or more second messages may be communicated in connection with an OTDOA or like positioning session, just to illustrate one possible implementation. Claimed subject matter is not so limited, of course. For example, in some instances, one or more second messages may be communicated in a separate message via any suitable proprietary communication and/or positioning protocol. Thus, in some instances, an LPPe, LPP/LPPe, RRC protocol (e.g., as defined in 3GPP TS 36.331, etc.), IS-801 protocol (e.g., as defined in 3GPP2 TS C.S0022, etc.), or the like may also be employed herein, in whole or in part, as was indicated. At times, one or more second messages may, for example, be transmitted via OTDOA positioning for UMTS access, Enhanced Observed Time Difference (E-OTD) for GSM or AFLT, or the like. Having received one or more second messages, a location server may, for example, incorporate observations of parameters of one or more PRS configurations into positioning assistance data, which may be provided to mobile devices of interest for subsequent positioning.

Accordingly, as discussed herein, targeted PRS configuration searches may provide benefits. For example, based, at least in part, on one or more operations and/or processes discussed herein, an OTA communication interface may be defined and/or established via leveraging existing infrastructure, such as of LTE or like technology. Since targeted PRS configuration searches may be implemented during a periodic refresh (e.g., once a day, etc.) over Wi-Fi links, for example, no extra WWAN wakeups are incurred. Also, since one or more PRS configurations are obtained via measuring a serving cell, possible hypotheses may be limited to 0 symbol offset, although making observations on neighbor cells may also be utilized, in whole or in part, such as in connection with one or more operations and/or techniques discussed herein. In addition, since there is no factory encoding on a mobile device, applicable adjustments with respect to new PRS configurations may, for example, be implemented more effectively and/or more efficiently via a location server and then provided to mobile devices of interest for implementation.

Also, targeted PRS configuration searches may make processing tasks for mobile devices rather minimal. Namely, as was indicated, a mobile device may be requested to leverage an OTDOA or like positioning session to measure a serving cell using one or more provided PRS configurations, such as if applicable conditions are met, for example, to collect and/or store, if also applicable, and/or to communicate obtained observations to a location server. Since these or like processing tasks are directed by a location server, a relatively larger number of different PRS configurations on different mobile devices within a particular geographic area may, for example, be searched and/or measured, meaning that a particular mobile device may not need to search and/or measure all or most PRS configurations.

In addition, because parameters indicative of one or more PRS configurations are rather stable and, once determined, do not typically change, a relatively smaller number of readings, such as to confirm consistency of PRS configuration results may, for example, be needed. As such, targeted PRS configuration searches may be limited to one or two measurement attempts per day. Thus, once PRS configurations are determined and/or obtained, an applicable process or interface may be turned off, and then enabled periodically, such as to check for network changes. Finally, no GNSS position fix and/or measurements is needed or otherwise useful for targeted PRS configuration searches, meaning that power consumption of battery-operated mobile devices may be improved. Of course, such a description of certain aspects of targeted PRS configuration searches and its benefits is merely an example, and claimed subject matter is not so limited.

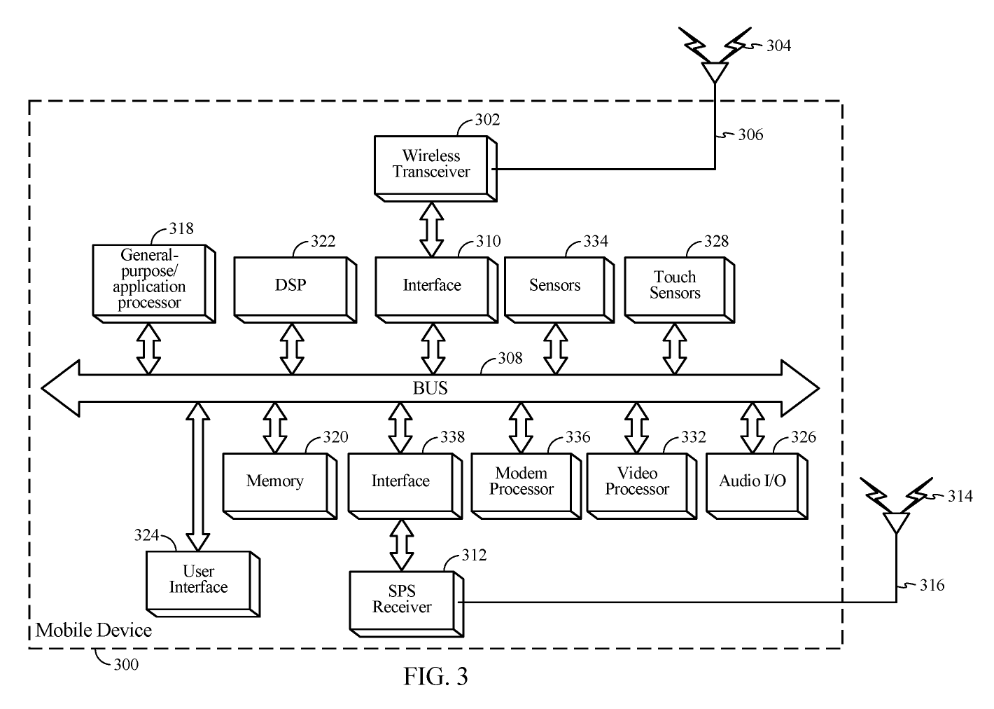

FIG. 3 is a schematic diagram of an implementation of an example computing environment associated with a mobile device that may be used, at least in part, to facilitate and/or support one or more operations and/or techniques for targeted PRS configuration searches. An example computing environment may comprise, for example, a mobile device 300 that may include one or more features or aspects of mobile device 102 of FIG. 1, though claimed subject matter is not so limited. For example, in some instances, mobile device 300 may comprise a wireless transceiver 302 capable of transmitting and/or receiving wireless signals, referenced generally at 304, such as via an antenna 306 over a suitable wireless communications network. Wireless transceiver 302 may, for example, be capable of sending or receiving one or more suitable communications, such as one or more communications discussed with reference to FIGS. 1 and 2. Wireless transceiver 302 may, for example, be coupled or connected to a bus 308 via a wireless transceiver bus interface 310. Depending on an implementation, at times, wireless transceiver bus interface 310 may, for example, be at least partially integrated with wireless transceiver 302. Some implementations may include multiple wireless transceivers 302 or antennas 306 so as to enable transmitting or receiving signals according to a corresponding multiple wireless communication standards such as WLAN or WiFi, Code Division Multiple Access (CDMA), Wideband-CDMA (W-CDMA), Long Term Evolution (LTE), Bluetooth®, just to name a few examples.

In an implementation, mobile device 300 may, for example, comprise an SPS or like receiver 312 capable of receiving or acquiring one or more SPS or other suitable wireless signals 314, such as via an SPS or like antenna 316. SPS receiver 312 may process, in whole or in part, one or more acquired SPS signals 314 for estimating a location of mobile device 300, initial or otherwise. In some instances, one or more general-purpose/application processors 318 (henceforth referred to as “processor”), memory 320, digital signal processor(s) (DSP) 322, or like specialized devices or processors not shown may be utilized to process acquired SPS signals 314, in whole or in part, calculate a location of mobile device 300, such as in conjunction with SPS receiver 312, or the like. Storage of SPS or other signals for implementing one or more positioning operations, such as in connection with one or more techniques for targeted PRS configuration searches, for example, may be performed, at least in part, in memory 320, suitable registers or buffers (not shown). Although not shown, it should be appreciated that in at least one implementation one or more processors 318, memory 320, DSPs 322, or like specialized devices or processors may comprise one or more processing modules capable of obtaining one or more observations of one or more terrestrial signals; storing the one or more observations in a local memory; retrieving, in response to an emergency event, the one or more stored observations for use, at least in part, in acquisition of one or more reference signals; and determining a position fix of mobile device 300 based, at least in part, on the one or more stored observations.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 318 or DSP 322 may include one or more processors, controllers, microprocessors, microcontrollers, application specific integrated circuits, digital signal processors, programmable logic devices, field programmable gate arrays, central processing units, graphics processor units, or the like, or any combination thereof. Thus, at times, processor 318 or DSP 322 or any combination thereof may comprise or be representative of means for receiving, from a location server, one or more first messages comprising a request to utilize one or more parameters indicative of one or more positioning reference signals (PRS) configurations, such as to implement operation 202 of FIG. 2, at least in part. In addition, in at least one implementation, processor 318 or DSP 322 may be representative of or comprise, for example, means for obtaining one or more observations of signals indicative of the one or more PRS configurations based, at least in part, on the request, such as to implement operation 204 of FIG. 2, at least in part. Also, at times, processor 318 or DSP 322 may comprise, for example, or be representative of means for transmitting one or more second messages to the location server, the one or more second messages comprising the one or more obtained observations of the signals indicative of the one or more PRS configurations, such as illustrated in or described with respect to operation 206 of FIG. 2, for example. In some instances, these or like operations may be implemented in connection with a communication interface, such interface 310 and/or 338.

As illustrated, DSP 322 may be coupled or connected to processor 318 and memory 320 via bus 308. Although not shown, in some instances, bus 308 may comprise one or more bus interfaces that may be integrated with one or more applicable components of mobile device 300, such as DSP 322, processor 318, memory 320, or the like. In various embodiments, one or more operations or functions described herein may be performed in response to execution of one or more machine-readable instructions stored in memory 320, such as on a computer-readable storage medium, such as RAM, ROM, FLASH, disc drive, etc., just to name a few examples. Instructions may, for example, be executable via processor 318, one or more specialized processors not shown, DSP 322, or the like. Memory 320 may comprise a non-transitory processor-readable memory, computer-readable memory, etc. that may store software code (e.g., programming code, instructions, etc.) that may be executable by processor 318, DSP 322, or the like to perform operations or functions described herein.

Mobile device 300 may comprise a user interface 324, which may include any one of several devices such as, for example, a speaker, microphone, display device, vibration device, keyboard, touch screen, etc., just to name a few examples. In at least one implementation, user interface 324 may enable a user to interact with one or more applications hosted on mobile device 300. For example, one or more devices of user interface 324 may store analog or digital signals on memory 320 to be further processed by DSP 322, processor 318, etc. in response to input or action from a user. Similarly, one or more applications hosted on mobile device 300 may store analog or digital signals in memory 320 to present an output signal to a user. In some implementations, mobile device 300 may optionally include a dedicated audio input/output (I/O) device 326 comprising, for example, a dedicated speaker, microphone, digital to analog circuitry, analog to digital circuitry, amplifiers, gain control, or the like. It should be understood, however, that this is merely an example of how audio I/O device 326 may be implemented, and that claimed subject matter is not limited in this respect. As seen, mobile device 300 may comprise one or more touch sensors 328 responsive to touching or like pressure applied on a keyboard, touch screen, or the like.

Mobile device 300 may comprise one or more sensors 334 coupled or connected to bus 308, such as, for example, one or more inertial sensors, ambient environment sensors, or the like. Inertial sensors of sensors 344 may comprise, for example, one or more accelerometers (e.g., collectively responding to acceleration of mobile device 300 in one, two, or three dimensions, etc.), gyroscopes or magnetometers (e.g., to support one or more compass or like applications, etc.), etc., just to illustrate a few examples. Ambient environment sensors of mobile device 300 may comprise, for example, one or more barometric pressure sensors, temperature sensors, ambient light detectors, camera sensors, microphones, etc., just to name few examples. Sensors 334 may generate analog or digital signals that may be stored in memory 320 and may be processed by DSP 322, processor 318, etc., such as in support of one or more applications directed to positioning or navigation operations, wireless communications, radio heat map learning, video gaming or the like.

In a particular implementation, mobile device 300 may comprise, for example, a modem processor 336, dedicated or otherwise, capable of performing baseband processing of signals received or downconverted via wireless transceiver 302, SPS receiver 312, or the like. Similarly, modem processor 336 may perform baseband processing of signals to be upconverted for transmission via wireless transceiver 302, for example. In alternative implementations, instead of having a dedicated modem processor, baseband processing may be performed, at least in part, by processor 318, DSP 322, or the like. In addition, in some instances, an interface 338, although illustrated as a separate component, may be integrated, in whole or in part, with one or more applicable components of mobile device 300, such as bus 308 or SPS receiver 312, for example. Optionally or alternatively, SPS receiver 312 may be coupled or connected to bus 308 directly. It should be understood, however, that these are merely examples of components or structures that may perform baseband processing, and that claimed subject matter is not limited in this regard.

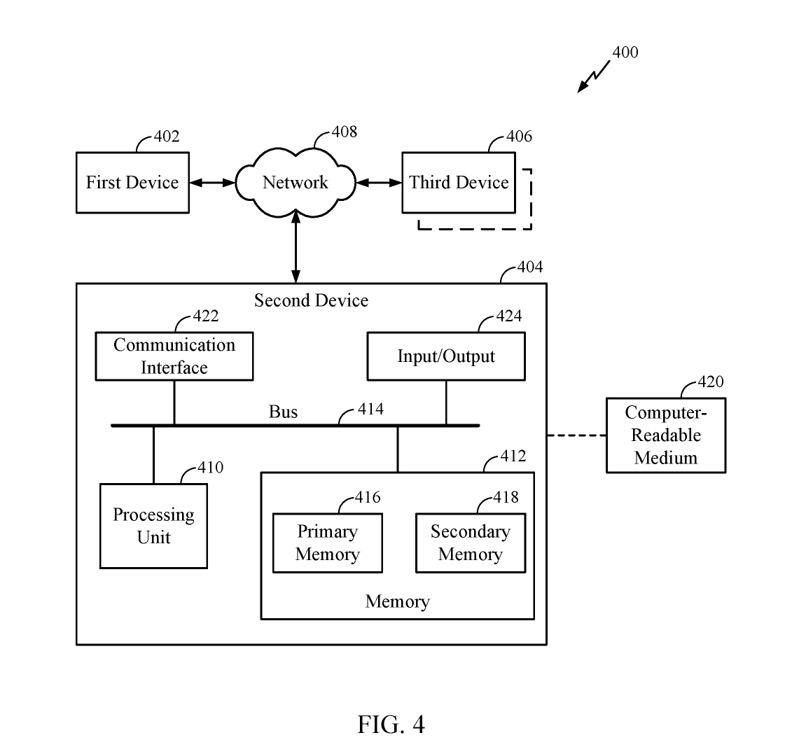

FIG. 4 is a schematic diagram illustrating an implementation of an example computing environment or system 400 that may be associated with or include one or more servers or other devices capable of partially or substantially implementing or supporting one or more operations and/or techniques for targeted PRS configuration searches, such as discussed above in connection with FIGS. 1 and 2, for example. Computing environment 400 may include, for example, a first device 402, a second device 404, a third device 406, etc., which may be operatively coupled together via a communications network 408. In some instances, first device 402 may comprise a location server capable of providing positioning assistance parameters, such as, for example, identities, locations, etc. of known wireless transmitters, radio heat map, base station almanac, electronic digital map, database of wireless transmitters, bias estimates, signal measurements, PRS configurations, or the like, such as discussed herein. For example, first device 402 may also comprise a server capable of providing an electronic digital map to a mobile device based, at least in part, on a coarse or rough estimate of a location of the mobile device (e.g., determined via last known SPS position fix, dead reckoning using one or more appropriate sensors, etc.), upon request, or the like. First device 402 may also comprise a server capable of providing any other suitable positioning assistance parameters (e.g., a radio heat map, etc.) relevant to a location of a mobile device. Second device 404 or third device 406 may comprise, for example, mobile devices, though claimed subject matter is not so limited. For example, in some instances, second device 404 may comprise a server functionally or structurally similar to first device 402, just to illustrate another possible implementation. In addition, communications network 408 may comprise, for example, one or more wireless transmitters, such as cellular base stations, Wi-Fi access points, femtocells, or the like. Of course, claimed subject matter is not limited in scope in these respects.

First device 402, second device 404, or third device 406 may be representative of any device, appliance, platform, or machine that may be capable of exchanging parameters and/or information over communications network 408. By way of example but not limitation, any of first device 402, second device 404, or third device 406 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 402, 404, and 406, respectively, may comprise one or more of a mobile device, wireless transmitter or receiver, server, etc. in accordance with example implementations described herein.

In an implementation, communications network 408 may be representative of one or more communication links, processes, or resources capable of supporting an exchange of information between at least two of first device 402, second device 404, or third device 406. By way of example but not limitation, communications network 408 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 406, there may be additional like devices operatively coupled to communications network 408. It is also recognized that all or part of various devices or networks shown in computing environment 400, or processes or methods, as described herein, may be implemented using or otherwise including hardware, firmware, software, or any combination thereof.

By way of example but not limitation, second device 404 may include at least one processing unit 410 that may be operatively coupled to a memory 412 via a bus 414. Processing unit 410 may be representative of one or more circuits capable of performing at least a portion of a suitable computing procedure or process. For example, processing unit 410 may include one or more processors, controllers, microprocessors, microcontrollers, application specific integrated circuits, digital signal processors, programmable logic devices, field programmable gate arrays, or the like, or any combination thereof. Although not shown, second device 404 may include a location-tracking unit that may initiate a position fix of a suitable mobile device, such as in an area of interest, for example, based, at least in part, on one or more received or acquired wireless signals, such as from an SPS, one or more cellular base stations, WLAN access points, etc. In some implementations, a location-tracking unit may be at least partially integrated with a suitable processing unit, such as processing unit 410, for example, though claimed subject matter is not so limited.

In certain server-based or server-supported implementations, processing unit 410 may, for example, comprise means for transmitting one or more first messages comprising a request to utilize one or more parameters indicative of one or more positioning reference signals (PRS) configurations, such as to facilitate or support operations 202, 204, 206, and/or 208 of FIG. 2, at least in part. In some instances, processing unit 410 may, for example, comprise means for initiating obtaining one or more observations of signals indicative of the one or more PRS configurations based, at least in part, on the request, such as to facilitate or support operations 202, 204, 206, and/or 208 of FIG. 2, at least in part. Depending on an implementation, processing unit 410 may also comprise, for example, means for receiving one or more second messages to the location server, the one or more second messages comprising the one or more obtained observations of the signals indicative of the one or more PRS configurations, such as to facilitate or support operations 202, 204, 206, and/or 208 of FIG. 2, at least in part.

Memory 412 may be representative of any information storage mechanism or appliance. Memory 412 may include, for example, a primary memory 416 and a secondary memory 418. Primary memory 416 may include, for example, a random access memory, read only memory, etc. While illustrated in this example as being separate from processing unit 410, it should be understood that all or part of primary memory 416 may be provided within or otherwise co-located/coupled with processing unit 410. Secondary memory 418 may include, for example, same or similar type of memory as primary memory or one or more information storage devices or systems, such as, for example, a disk drive, an optical disc drive, a tape drive, a solid state memory drive, etc. In certain implementations, secondary memory 418 may be operatively receptive of, or otherwise configurable to couple to, a computer-readable medium 420. Computer-readable medium 420 may include, for example, any non-transitory storage medium that may carry or make accessible information, code, or instructions for one or more of devices in computing environment 400. Computer-readable medium 420 may also be referred to as a machine-readable medium, storage medium, or the like.

Second device 404 may include, for example, a communication interface 422 that may provide for or otherwise support an operative coupling of second device 404 to at least communications network 408. By way of example but not limitation, communication interface 422 may include a network interface device or card, a modem, a router, a switch, a transceiver, and the like. Second device 404 may also include, for example, an input/output device 424. Input/output device 424 may be representative of one or more devices or features that may be configurable to accept or otherwise introduce human or machine inputs, or one or more devices or features that may be capable of delivering or otherwise providing for human or machine outputs. By way of example but not limitation, input/output device 424 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method, at a mobile device, comprising:
receiving, from a location server, one or more first messages comprising a request to utilize one or more parameters indicative of one or more positioning reference signals (PRS) configurations expected to be observed in a particular area, the one or more parameters selected to be evaluated by the mobile device to detect a change in operational validity of the one or more PRS configurations;
obtaining one or more observations of signals indicative of the one or more PRS configurations based, at least in part, on the request; and
transmitting one or more second messages to the location server, the one or more second messages comprising the one or more obtained observations of the signals indicative of the one or more PRS configurations.

2. The method of claim 1, wherein the one or more first messages specify one or more candidate parameters indicative of the one or more PRS configurations.

3. The method of claim 1, wherein the one or more parameters indicative of the one or more PRS configurations comprise at least one of: a PRS bandwidth; a PRS configuration index; a number of successive subframes; a PRS muting pattern; a cyclic prefix; a number of transmitter antennas on a transmitting device, or a combination thereof.

4. The method of claim 1, wherein the request further specifies that the one or more observations of the signals indicative of the one or more PRS configurations are to be obtained while the mobile device is camped on a PRS transmitter.

5. The method of claim 4, wherein the PRS transmitter comprises a serving cellular base station or a serving wireless local area network (WLAN) access point.

6. The method of claim 1, wherein the one or more first messages specify one or more of a time and a geographic area within which the one or more observations are to be obtained.

7. The method of claim 1, wherein the one or more first messages specify a specific PRS transmitter or a specific group of PRS transmitters to be observed.

8. The method of claim 7, wherein the one or more first messages further specify one or more transmit frequencies for the specific PRS transmitter or the specific group of PRS transmitters to be observed.

9. The method of claim 1, wherein the one or more first messages request observations of previously undiscovered PRS configurations.

10. The method of claim 1, wherein the one or more first messages request updated observations of the one or more parameters indicative of the one or more PRS configurations.

11. The method of claim 1, wherein the one or more first messages request to obtain the observations via at least one of: a normal measurement mode; a PRS bandwidth measurement mode; an I_{PRS} measurement mode; a cell-specific measurement mode; a sequential PRS bandwidth measurement mode; a parallel PRS bandwidth measurement mode, or a combination thereof.

12. The method of claim 1, wherein the one or more observations of the signals indicative of the one or more PRS configurations are obtained in connection with performing one or more observed time difference of arrival (OTDOA) measurements or time of arrival (TOA) measurements and in the absence of Global Navigation Satellite System (GNSS) measurements.

13. The method of claim 1, wherein the location server comprises a proprietary server not operated by a carrier network of the mobile device.

14. The method of claim 1, wherein the location server comprises: an Enhanced Serving Mobile Location Center (E-SMLC); a Home Serving Mobile Location Center (H-SMLC); a Secure User Plane Location (SUPL) Location Platform (SLP); or an emergency SLP (eSLP).

15. The method of claim 1, wherein the one or more first or the one or more second messages are transmitted according to at least one of: an LTE positioning protocol (LPP); an LPP extensions (LPPe) protocol; a Secure User Plane Location (SUPL) user plane location protocol (ULP); a Location Services Application Protocol (LCS-AP) control plane protocol; a proprietary protocol, or any combination thereof.

16. An apparatus comprising:
means for receiving, from a location server, one or more first messages comprising a request to utilize one or more parameters indicative of one or more positioning reference signals (PRS) configurations expected to be observed in a particular area, the one or more parameters selected to be evaluated by a mobile device to detect a change in operational validity of the one or more PRS configurations;
means for obtaining one or more observations of signals indicative of the one or more PRS configurations based, at least in part, on the request; and
means for transmitting one or more second messages to the location server, the one or more second messages comprising the one or more obtained observations of the signals indicative of the one or more PRS configurations.

17. The apparatus of claim 16, wherein the one or more first messages specify one or more candidate parameters indicative of the one or more PRS configurations.

18. The apparatus of claim 16, wherein the one or more first messages request to obtain the observations via at least one of: a normal measurement mode; a PRS bandwidth measurement mode; an I_{PRS} measurement mode; a cell-specific measurement mode; a sequential PRS bandwidth measurement mode; a parallel PRS bandwidth measurement mode, or a combination thereof.

19. An apparatus comprising:
a communication interface coupled to a receiver of a mobile device to communicate with an electronic communications network and one or more processors coupled to a memory and to the communication interface, the communication interface and the one or more processors configured to:
receive, from a location server, one or more first messages comprising a request to utilize one or more parameters indicative of one or more positioning reference signals (PRS) configurations expected to be observed in a particular area, the one or more parameters selected to be evaluated by the mobile device to detect a change in operational validity of the one or more PRS configurations;
obtain one or more observations of signals indicative of the one or more PRS configurations based, at least in part, on the request; and
initiate a transmission of one or more second messages to the location server, the one or more second messages comprising the one or more obtained observations of the signals indicative of the one or more PRS configurations.

20. The apparatus of claim 19, wherein the one or more first messages specify one or more candidate parameters indicative of the one or more PRS configurations.

21. The apparatus of claim 19, wherein the one or more parameters indicative of the one or more PRS configurations comprise at least one of: a PRS bandwidth; a PRS configuration index; a number of successive subframes; a PRS muting pattern; a cyclic prefix; a number of transmitter antennas on a transmitting device, or a combination thereof.

22. The apparatus of claim 19, wherein the one or more first messages specify one or more of a time and a geographic area within which the one or more observations are to be obtained.

23. The apparatus of claim 19, wherein the one or more first messages specify a specific PRS transmitter or a specific group of PRS transmitters to be observed.

24. The apparatus of claim 23, wherein the one or more first messages further specify one or more transmit frequencies for the specific PRS transmitter or the specific group of PRS transmitters to be observed.

25. The apparatus of claim 19, wherein the one or more first messages request observations of previously undiscovered PRS configurations.

26. The apparatus of claim 19, wherein the one or more first messages request updated observations of the one or more parameters indicative of the one or more PRS configurations.

27. The apparatus of claim 19, wherein the one or more first messages request to obtain the observations via at least one of: a normal measurement mode; a PRS bandwidth measurement mode; an I_{PRS} measurement mode; a cell-specific measurement mode; a sequential PRS bandwidth measurement mode; a parallel PRS bandwidth measurement mode, or a combination thereof.

28. A non-transitory storage medium having instructions executable by a processor to:
receive, from a location server, one or more first messages comprising a request to utilize one or more parameters indicative of one or more positioning reference signals (PRS) configurations expected to be observed in a particular area, the one or more parameters selected to be evaluated by a mobile device to detect a change in operational validity of the one or more PRS configurations;
obtain one or more observations of signals indicative of the one or more PRS configurations based, at least in part, on the request; and
initiate a transmission of one or more second messages to the location server, the one or more second messages comprising the one or more obtained observations of the signals indicative of the one or more PRS configurations.

29. The non-transitory storage medium of claim 28, wherein the one or more parameters indicative of the one or more PRS configurations comprise at least one of: a PRS bandwidth; a PRS configuration index; a number of successive subframes; a PRS muting pattern; a cyclic prefix; a number of transmitter antennas on a transmitting device, or a combination thereof.

30. The non-transitory storage medium of claim 28, wherein the one or more first messages request to obtain the observations via at least one of: a normal measurement mode; a PRS bandwidth measurement mode; an I_{PRS} measurement mode; a cell-specific measurement mode; a sequential PRS bandwidth measurement mode; a parallel PRS bandwidth measurement mode, or a combination thereof.
